(19) United States
(12) Patent Application Publication
(10) Pub. No.: US 2004/0250010 A1
(43) Pub. Date: Dec. 9, 2004

(54) Storage device available for increasing storage capacity

(75) Inventors: Chia-Li Chen, Hsindien City (TW); Hsiang-An Hsieh, Hsindien City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/685,499

(22) Filed: Oct. 16, 2003

(30) Foreign Application Priority Data
Jun. 5, 2003 (TW) 092115320

(51) Int. Cl. G06F 12/00

(52) U.S. Cl. 711/103; 711/170

(57) ABSTRACT

The present invention provides a storage device available for increasing storage capacity, mainly comprising a controller and at least a solid-state storage medium; wherein said controller has at least a interface that may be connected to an external system, a microprocessor processing system instructions, and a memory interface communicates to said solid-state storage medium (media); said controller, through an appropriate compressing/decompressing mechanism, compresses original data transferred from the external system to minimized data in 1/N ratio and write it to said solid-state storage medium (media), in order to achieve more storage capacity in said solid-state storage medium (media).

### FIELD OF THE INVENTION

The present invention relates to a storage device available for increasing storage capacity, in particular a storage device that utilizes compression technology to compress the data to be stored to boost data storage capacity.

### BACKGROUND OF THE INVENTION

Today, solid-state storage products utilizing silicon wafers as the storage media have been widely used, such as flash memory cards. Due to the unique features of silicon storage media such as low power consumption, high reliability, high capacity, and high access speed, they are widely used in storage devices such as memory cards and USB U-disks. Such a memory device has not only an internal solid-state storage medium but also a controller, which has a system interface that may be connected to an external system, a microprocessor processing system instructions, and a memory interface communicating with the solid-state storage medium and write the data from the system into the solid-state storage medium or read the data stored in the solid-state storage medium.

Memory cards and USB U-disks are used in different fields: memory cards are used in today's popular portable digital products such as digital cameras, digital MP3 players, PDAs, etc., and there are different kinds of memory cards from different manufacturers, such as CF cards, MS cards, SD cards, MMCs, and SM cards, etc.; said USB U-disks may be easily used in personal computer field such as desktop computers or notebook computers through their USB interfaces, and due to their easy-to-use and portable nature, they have become popular storage products in recent years.

However, whether for memory cards or for USB U-disks, the production costs and sales prices depend on the capacity of their embedded solid-state storage media, for example, there are 64 MB, 128 MB, and 256 MB storage media currently available, and the cost and sales price are in proportion to the capacity of embedded storage media, i.e., the higher the capacity of embedded storage medium is, the higher the price of the storage device is. However, as the hardware manufacturing technology develops to a certain degree, solid-state storage media have encountered the same embarrassment as today's CD-R disks, i.e., the storage capacity per unit area of silicon wafer can't be increased further. Though the emerging nanometer technologies may further reduce the granularity of storage space to increase the storage capacity, the technology is in the budding age and still can't be used to overcome above embarrassment.

In practice, there is a way to solve above problem, i.e., devise another socket at an appropriate position on the body of said storage device (memory card or USB U-disk) to insert an external memory card to expand the storage capacity of the memory device. Though that way may solve the problem of insufficient storage capacity, it requires additional external memory cards, which leads to cost increase.

Therefore, it is expected to develop a storage device that may minimize the data to be stored through enhancing the data processing capability of the internal controller and utilizing an appropriate compression mechanism without additional solid-state storage medium or external storage device. In that way, such a device may boost the data storage capacity without increasing hardware storage resource of the storage device.

### SUMMARY OF THE INVENTION

In consideration of above problems, the object of the present invention is to provide a storage device available for increasing the storage capacity; said storage device mainly comprises a controller and at least a solid-state storage medium; said controller has a system interface that may be connected to an external system, a microprocessor processing system instructions, and a memory interface that may communicate with said solid-state storage medium (media), wherein: With an appropriate compression mechanism, said controller may compress the original data to be stored in 1/N ratio to minimize the data and store the compressed data into said solid-state storage medium (media); therefore, with the compression mechanism, the volume of original data may be reduced significantly, thus the storage space of said solid-state storage medium (media) may accommodate more data. Such an approach not only boosts the data storage capacity, but also decreases product cost and increases data access speed.

Above and other purposes, characteristics, and benefits are further described in the following embodiments, with reference to the attached drawings.

### BRIEF DESCRIPTION OF THE DRAWINGS

FIG. 1 is a sketch diagram of the circuit of a preferred embodiment implemented according to the invention.

FIG. 2 shows the difference between uncompressed state and compressed state of the embodiment in FIG. 1.

1: Storage Device

10: Controller

101: System Interface

102: Microprocessor

103: Memory Interface

104: Data Compression Module

105: Data Decompression Module

106: First Data Cache

107: Second Data Cache

20: Solid-State Storage Medium

2: External System End

### EMBODIMENT OF THE INVENTION

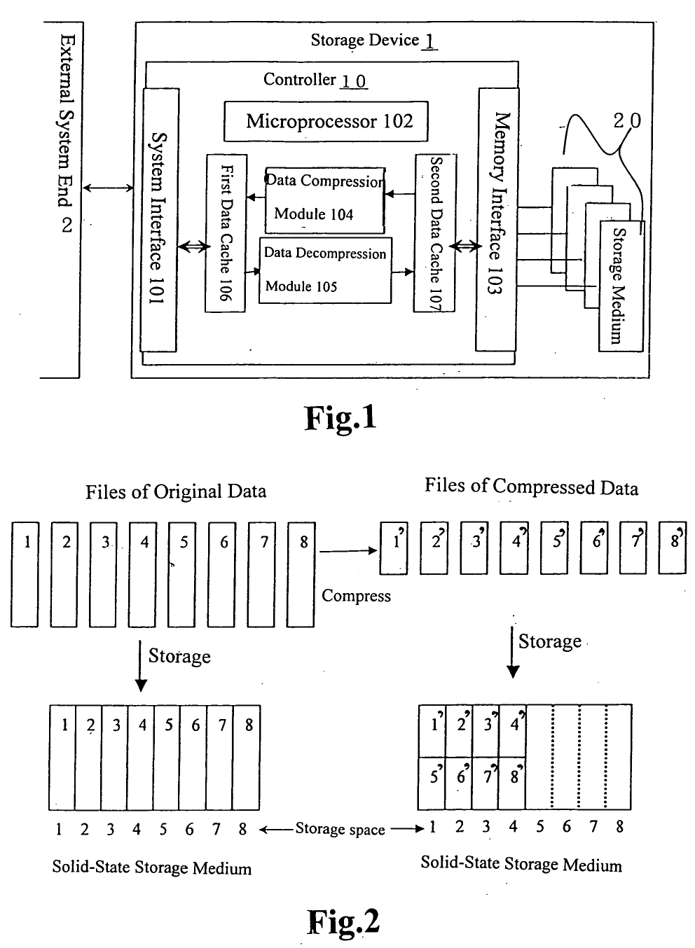

Please see FIG. 1, a sketch diagram of the internal circuit of the storage device available for increasing storage capacity; wherein the storage device 1 may be a memory card widely used in various portable digital products or a USB U-disk used in PC field, or a storage device with solid-state store media (i.e., Flash Memory) that are under development currently.

Wherein said storage device 1 mainly comprises a controller 10 and at least a solid-state storage medium 20; said controller 10 comprises an internal system interface 101, a microprocessor 102, and a memory interface 103. Said system interface 101 is used to connect an external system 2 (i.e., a portable digital product or a PC system as described above); said memory interface 103 communicates with said solid-state storage medium 20; said microprocessor 102 is connected to said system interface 101 and said memory interface 103.

As shown in FIG. 1, to boost the storage capacity of the solid-state storage medium 20, a data compression module 104 and a data decompression module 105 are devised in said storage device 1; wherein said data compression module 104 and said data decompression module 105 are connected to said microprocessor 102 respectively to act under the instructions of said microprocessor 102 (the actions will be discussed in later part of the document). In addition, in consideration of the difference in transmission speed between the high-speed interface and the low-speed interface, a first cache 106 and a second cache 107 are devised; wherein the first cache 106 is electrically connected to said data compression module 104, said data decompression module 105 and said system interface 101; the second cache 107 is electrically connected to said data compression module 104, said data decompression module 105 and said memory interface 103. Both said cache 106 and cache 107 are used to store data, but the forms of data in them are different from each other, which will be described in later part of the document.

When data from exterior is to be stored in the solid-state storage medium in said storage device, said system interface 101 receives original data transferred from the external system end 2; said microprocessor 102 compresses the original data with the data compression module 104 in an appropriate ratio (e.g., 1/N, where “N” depends on the compression algorithm used and may be 2, 3, 4, . . . ) to reduced volume, then stores the compressed data into the solid-state storage medium 20 of said storage device via said memory interface 103. Thus the storage capacity of said storage device is boosted by “N” times in that way.

In the design of the present invention, before the system interface 101 transfers original data to compress, it stores the original data in the first data cache 106. The data compression module 104 retrieves original data from the first cache 106 at a specific bit rate and compresses the original data, then it transfers the compressed data to the second data cache 107 to store. Next, the microprocessor 102 stores the compressed data in the second data cache 107 into the solid-state storage medium 20 via the memory interface 103.

When the external system end 2 needs to access the data stored in the solid-state storage medium 20 of the storage device 1, it utilizes the data decompression module 105 to decompress the data retrieved from the solid-state storage medium 20 through the memory interface 103, and then transfers the decompressed data to the external system end 2 via the system interface 101.

Actually, before the memory interface 103 transfers the compressed data to decompress, it stores the compressed data in the second cache 107; then the data decompression module 105 retrieves data from the second data cache 107 and decompresses it, and then transfers the decompressed data to the first data cache 106. Next, the microprocessor 102 detects the reproduced data stored in the first data cache 106 and transfers the reproduced data to the external system end 2 via the system interface 101.

Said data compression module 104 and data decompression module 105 may be implemented with hardware or firmware (software).

To help the reader to understand better the difference between uncompressed state and decompressed state of the invention, FIG. 2 shows the comparison between them, with reference to FIG. 1. In the embodiment, the compression ratio is set to 2:1. However, it should be noted that the value of compression ratio is not limited to 2:1.

When the external system end 2 requests to write original data to the storage device 1, the system interface 101 transfers the files of original data (e.g., file 1, 2, 3, 4, 5, 6, 7, 8 in FIG. 2; note: suppose those files of original data are processed to contain the same volume of original data) to the first data cache 106. As soon as the microprocessor 102 detects the original data, it instructs the data compression module 104 to compress the original data into corresponding compressed files (e.g., file 1′, 2′, 3′, 4′, 5′, 6′, 7′, 8′ in FIG. 2) and transfers the compressed files to the second data cache 107; at this time, the microprocessor 102 may clear the original data stored in the first data cache 106 and requests the system end 2 to transfer other files of original data to store; on the other hand, the microprocessor 102 stores the compressed data in the second data cache 107 into the solid-state storage medium 20 via the memory interface 103.

Please see FIG. 2, an embodiment of the present invention. The lower-left corner of FIG. 2 shows that the files of uncompressed data (original data) occupies 8 storage units in the solid-state storage medium 20; the lower-right corner of FIG. 2 shows that the compressed files only occupy 4 storage units in solid-state storage medium 20 (compression ratio: 2:1) In other words, with the compression technology in the present invention and through utilizing controller 10 and the communication bandwidth between the system interface 101 and the memory interface 103 during transmission, the logical data storage capacity of the solid-state storage medium 20 may be boosted to N times, without altering the physical storage capacity. For example, the 8 storage units, at full load, may store 16 compressed files, which means the number of files that may be stored in the solid-state storage medium 20 has doubled. In addition, due to the fact that the data volume is reduced significantly through compression, the speed of data transmission and storage has increased. Thus the access speed of the storage device improves. Furthermore, besides above benefits, owing that the compression technology is used in the present invention, the consumers may purchase storage devices with lower storage capacity, which are equivalent to storage devices with higher storage capacity in storage efficacy.

The present invention is disclosed as above with preferred embodiment. However, it is noted that above embodiment shall not constitute any limitation to the invention. Any skilled in this art may carry out modifications or embellishments to the embodiment without escaping the spirit and scope of the invention. Therefore, the scope of the invention is defined with the attached claims. Any embodiment implemented with equivalent modifications or embellishments to the invention (e.g., separate said data compression module and said data decompression module from the controller) shall fall in the scope of the invention.

1. A storage device available for increasing storage capacity, comprising a controller and at least a solid-state storage medium; said controller having a system interface connected to external system end, a microprocessor processing system instructions, and a memory interface communicating with said solid-state storage medium; wherein: said controller has a data compression module between said system interface and said memory interface, and the data compression module compresses the original data transferred from the system interface in 1/N compression ratio under the control of the microprocessor and then stores the compressed data into said solid-state storage medium via said memory interface:

2. A storage device available for increasing storage capacity according to claim 1, wherein said storage device has a data decompression module between said system interface and said memory interface; said decompression module, under the control of said microprocessor, retrieves compressed data stored in said solid-state storage medium and decompresses it to original data to output.

3. A storage device available for increasing storage capacity according to claim 1 or 2, wherein said storage device has a first data cache electrically connected to said system interface, said microprocessor, said data compression module and said data decompression module.

4. A storage device available for increasing storage capacity according to claim 1 or 2, wherein said controller has a second data cache electrically connected to said memory interface, said microprocessor, said data compression module and said data decompression module.

5. A storage device available for increasing storage capacity according to claim 1 or 2, wherein said data compression module and said data decompression module are in said controller.
